(19) United States
(12) Patent Application Publication
(10) Pub. No.: US 2005/0080898 A1
(43) Pub. Date: Apr. 14, 2005

(54) System and method for managing computer usage

(76) Inventor: Jerald J. Block, Portland, OR (US)

Correspondence Address: KOLISCH HARTWELL, P.C., 520 S.W. YAMHILL STREET, SUITE 200, PORTLAND, OR, 97204, US

(21) Appl. No.: 10/961,281

(22) Filed: Oct. 8, 2004

Related U.S. Application Data
(60) Provisional application No. 60/509,873, filed on Oct. 8, 2003.

(51) Int. Cl. G06F 12/00

(52) U.S. Cl. 709/225

(57) ABSTRACT

A system and method for managing computer usage. The system includes an interposed software process configured to activate in response to a request to launch an application program on a computer. The system employs the interposed software process and a database to identify the application program, determine whether any management information is associated with the application and, if there is associated management information, manage usage of the application program. Typically, the management information is stored in the database and includes one or more usage constraints specifying how the application program is to be used. The usage constraints may include permitting or denying execution of applications based on user identity, content or subject matter of application, time of day, cumulated usage time and/or various other criteria.

### CROSS-REFERENCE TO PRIORITY APPLICATIONS

This application is based upon and claims the benefit under 35 U.S.C. § 119(e) of the following U.S. provisional patent application, which is incorporated herein by reference in its entirety for all purposes: Ser. No. 60/509,873, filed Oct. 8, 2003.

### BACKGROUND

Various systems and methods have been implemented to manage (e.g., control and/or monitor) the usage of personal computers. One area where such systems and methods have been employed is in monitoring and controlling computer usage by children, for example to prevent them from accessing websites containing objectionable content. Typical monitoring programs include a list of blocked websites that is compiled by the publisher of the monitoring program. Attempts by the user to access any site on the block list are prevented by the monitoring software. Though some control over usage is achieved, this and similar systems are often very limited in the type of control that can be exerted, and it is often difficult or impossible for an operator of the software (e.g., a parent) to flexibly configure the software to customize its operation. More particularly, these systems are limited in that they only prevent Internet-related activities, they are not able to impose generalized program control or content-specific time limits, and in many cases the access blockage is based entirely on the software manufacturer's decision as to whether a website is objectionable.

Other prior monitoring/control solutions include limiting a personal computer to a pre-defined list of approved applications, known as a “whitelist”. Alternatively, certain users of the computer may be “blacklisted” from running one or more applications from a pre-defined list of applications. However, this solution requires an administrator of the system (e.g., a parent) to have significant prior knowledge of a program in order to make an informed decision about whether and when it can be accessed by a user (e.g., a child in the household). Also, the software typically needs to be updated on a regular basis as new products become available or are installed on the computer. Also, the prior systems commonly ban access to system utilities and operating system tools so that new applications cannot be installed. While “locking down” a system may prevent hacking or inappropriate computer programs from being installed, in many cases it will deny the user access to critical utilities/tools and generate an inflexible and uncreative working environment.

Finally, all prior solutions presuppose that the administrator, often a parent, should be able to override any restrictions that they, themselves, setup. This might be the case for a parent or employer that wants to limit other people from accessing objectionable content but also retain the ability to make exceptions, as they wish. An important exception to this model is where the system administrator wishes to set limits which, once configured, even they do not have the immediate authority to reverse. Such an exception is important in the treatment of compulsive or addictive disorders, where for a brief period an individual may have the insight and motivation to make such behavioral restrictions or goals that cannot be easily reversed. Thus, prior solutions are inadequate to address issues such as computer-mediated compulsive gaming, gambling, internet use, pornographic viewing, chatting, emailing, or just simply addictive computer use.

### BRIEF DESCRIPTION OF THE DRAWINGS

FIG. 1 depicts an exemplary system and method according to the present description for managing computer usage by a supervised user.

FIG. 2 depicts an exemplary computer that may be used in connection with the software, systems and methods of the present description.

FIGS. 3-9 depict exemplary aspects of systems and methods for managing computer usage.

### DETAILED DESCRIPTION

The exemplary methods and systems of the present description include a software program adapted to monitor and control usage of a personal computer. Typically, the software is configured by a supervising user (e.g., a parent, network administrator, etc.) to manage computer usage by a supervised user (e.g., a child, employee, etc.). However, the exemplary system may also be configured by a supervising user to surrender control of the system to some exterior entity and/or for some period of time. In this special circumstance, the authority is, in effect, managed by their own system settings. The exemplary system may be configured to manage computer usage based on one or more of the following criteria: (1) whether the application is specified as being permitted or prohibited, for example by inclusion on a “black list” or “white list”; (2) a rating of the application, established by the supervising user or a third party; (3) content of the application, such as violent or sexual content, as determined by the supervising user or a third party; (4) identity of the supervised user or other information associated with the supervised user; (5) time of day; and (6) accumulated time of computer usage or usage of specified applications. Many other criteria and combinations of criteria may be employed in addition to or instead of the criteria listed above. Depending on the assessed criteria, a particular application may be allowed to run, prevented from running, closed down after being initially allowed to run, etc. In addition to or instead of the above actions, the management software may simply passively record activity associated with the application being run.

Although the present examples are described primarily in the context of Windows-based operating systems, it will be appreciated that the systems and methods described herein may be readily implemented in other environments, such as Linux, Mac OS-X, Solaris, AIX, HPUX, gaming consoles (Xbox, PS2, etc.), mobile telephones, portable computing devices, and BSD-derived operating systems, to name but a few examples.

Typically, management functions such as those described above are facilitated through use of an interposed process, such as a hook or other software/hardware mechanism that is responsive to launching of application programs on the computer, for example via “interrupt” type functionality. The interposed process can be in the form of a ready-made system resource, such as the Windows API Global Shell Hooks, or custom made as a software driver. For ease of explanation, in the exemplary embodiments described herein, a system-wide shell hook is described. Alternate embodiments may use the software driver approach. Thus, references herein to interposed processes or shell hooks can alternatively refer to a software driver that hooks the initiation of new processes.

Among other things, the interposed software process (e.g., a shell hook) may be adapted to detect the startup of new applications. On startup, the interposed process delays execution of the requested application and performs or initiates performance of one or more management functions via interrupt-type processing. These management functions may be performed by the interposed process or a separate component, and may include: (1) identifying the application by its unique hash signature(s), (2) updating a log with the name of the requested application, (3) writing of an update to the same log indicating the date and time, (4) effecting a database call to an applications database to determine if the requested program has associated management information, which may include information about whether the application should be allowed to execute and, (5) acting on the derived information to either allow the application to launch or not.

As explained in detail below, the applications database may be generated by a third party, by the supervising user, and/or through local customization of an external third party database. Typically, the database call yields a unique identification of the requested application program. The system then retrieves management information from the database that has been associated with the given application. The management information may include time-based or other usage constraints, and/or other information specifying how the computer and applications running thereon are to be managed. For example, based on the management information, the system may permit the requested application to run normally or prevent the launching of the application. The management information may also include a time-based usage constraint specifying permitted times of usage or a cumulative permitted duration of use. The exemplary software described herein may also be used to perform other management functions, such as updating various logs to reflect the actions taken.

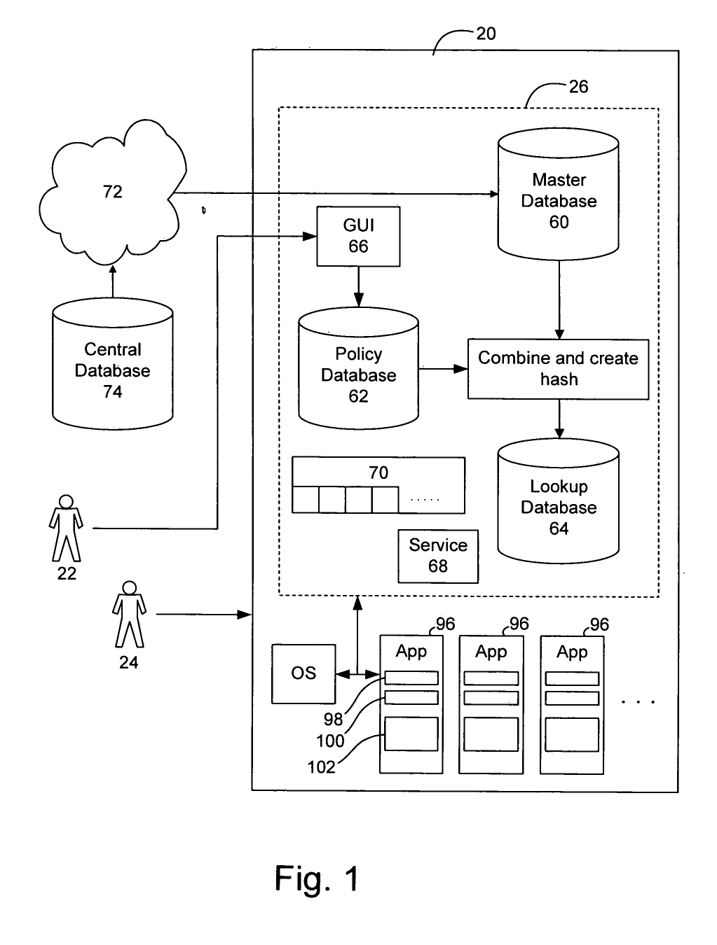

Referring now to FIGS. 1-7, exemplary systems and methods will be described. Beginning with FIG. 1, an exemplary system 20 for managing computer usage is depicted. Computer 20 is used by a supervising user or supervisor 22 and a supervised user 24. As discussed above, supervisor 22 configures management software 26 installed on computer 20, so that the management software monitors and controls the usage of computer 20 by supervised user 24.

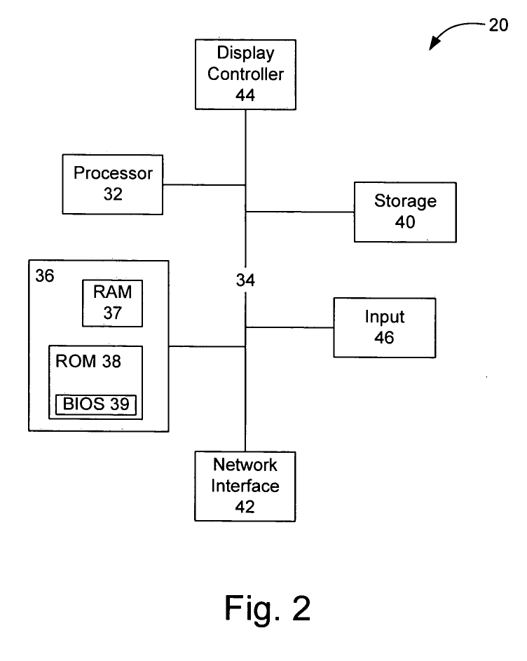

FIG. 2 schematically depicts an exemplary computer 20 that may be employed in connection with, and managed by, the software, systems and methods of the present description. Computer system 20 includes a processor 32 that processes digital data. The processor may be a complex instruction set computing (CISC) microprocessor, a reduced instruction set computing (RISC) microprocessor, a very long instruction word (VLIW) microprocessor, a processor implementing a combination of instruction sets, a microcontroller, or virtually any other processor/controller device. The processor may be a single device or a plurality of devices.

Referring still to FIG. 2, it will be noted that processor 32 is coupled to a bus 34 which transmits signals between the processor and other components in the computer system. Those skilled in the art will appreciate that the bus may be a single bus or a plurality of buses. A memory 36 is coupled to bus 34 and comprises a random access memory (RAM) device 37 (referred to as main memory) that stores information or other intermediate data during execution by processor 32. Memory 36 also includes a read only memory (ROM) and/or other static storage device 38 coupled to the bus that stores information and instructions for processor 32. A basic input/output system (BIOS) 39, containing the basic routines that help to transfer information between elements of the computer system, such as during start-up, is stored in ROM 38. A data storage device 40 also is coupled to bus 34 and stores information and instructions. The data storage device may be a hard disk drive, a floppy disk drive, a CD-ROM device, a flash memory device or any other mass storage device. In the depicted computer system, a network interface 42 also is coupled to bus 34. The network interface operates to connect the computer system to a network (not shown).

Computer system 20 may also include a display device controller 44 coupled to bus 34. The display device controller allows coupling of a display device to the computer system and operates to interface the display device to the computer system. The display device controller 44 may be, for example, a monochrome display adapter (MDA) card, a color graphics adapter (CGA) card, or other display device controller. The display device (not shown) may be a television set, computer monitor, cell phone display, flat panel display or other display device. The display device receives information and data from processor 32 through display device controller 44 and displays the information and data to the user of computer system 20.

An input device 46, including alphanumeric and other keys, typically is coupled to bus 34 for communicating information and command selections to processor 32. Alternatively, input device 46 is not directly coupled to bus 34, but interfaces with the computer system via infra-red coded signals transmitted from the input device to an infra-red receiver in the computer system (not shown). The input device may also be a remote control unit having keys that select characters or command selections on the display device.

Referring again to FIG. 1, management software 26 on computer 20 may include a master database 60 and policy database 62 (e.g., stored within storage 40), which are merged or otherwise combined to form a lookup database 64. Management software 26 may further include a supervisor interface, such as GUI 66, a service 68 and an interposed process such as shell hook 70. Master database 60 typically is obtained from an external source (e.g., a third party provider) via a communications link, and often will take the form of a local copy of an external database. For example, in the depicted exemplary system, master database 60 is obtained via Internet 72, and is a local copy of central database 74.

As explained in detail below, central database 74 typically is created and maintained externally by a third party. Central database 74 may include information about a large number of software applications that could be run on computer 20 by either user 22 or user 24. Policy database 62 typically includes local parameters corresponding to individualized preferences and requirements of supervisor user 22 about how computer 20 is to be used by supervised user 24 (or, in the case of compulsive computer use, user 22 may be restricted, as discussed later). For example, while management software 26 is in “setup mode,” supervisor 22 could specify that entertainment-type software can only be run at a certain time of day, or that supervised user 24 cannot use any software having certain ratings assigned by a third party (e.g., an Entertainment Software Rating Board rating). In an employment setting, the management software may be configured to allow only certain employees to access specified software applications, to limit usage of certain applications, to record time spent using certain applications, etc. A wide variety of customizable parameters may be specified by supervisor 22 and stored within policy database 62. Additional examples are discussed below.

Master database 60 and policy database 62 typically are combined to create lookup database 64, which is regularly consulted during run-time operation of management software 26. Lookup database 64 contains, for one or more managed applications that can be run on computer 20, management information that is used in controlling usage of the respective application. Combining master database 60 and policy database 62 allows for creation of an efficiently-sized database (i.e., lookup database 64), to optimize database calls and minimize delays associated with management tasks performed by management software 26. For example, master database 60 could contain information pertaining to a significant portion of the commercially available software applications, such that the database could have tens of thousands of records. Supervisor 22 might only be interested in managing usage of a few of these programs (e.g., the programs that are locally installed on computer 20). Or, as another example, assume supervisor 22 was a parent primarily interested in preventing a child from using extremely violent computer games. In this case, lookup database 64 would be relatively small, in that it would only include information associated with applications installed on computer 20 and that had been identified (by the parent or a third party) as being particularly violent.

Management information may include time-based and other usage constraints, that may be applied individually or in any combination to manage usage of computer 20 or applications running thereon. For example, for a given application or use of computer, the management information may include indication of: (1) age-level appropriateness, (2) sexual subject matter, (3) violent subject matter, (4) religious subject matter, (5) the nature of the subject matter (e.g., game used for gambling, educational software appropriate for all age levels, file-sharing software, etc.), (6) the type of application (e.g., game, educational, etc.), (7) that the application/use is specifically prohibited or permitted, (8) permitted or prohibited lists of users, (9) permitted usage times, (10) permitted usage duration over a given interval, (11) third-party evaluations of software, such as ratings, (12) whether the software has significant uses that raise legality questions, such as file-sharing software, (13) whether the application/use poses some threat to any user of the computer, such as a online gambling game in the household of a gambling addict, etc.

Any combination of these parameters may be employed to formulate policies concerning how computer 20 is to be managed. For example, the management information may include the following exemplary policies: (1) that if the logged-in user is under 12 years of age, no applications may be run after a certain time in the evening, (2) that certain users are prohibited from using applications that access the Internet, (3) that certain users can only access the Internet for 5 hours per week, (4) that certain excessively used games be only accessible at certain times, (5) that games containing violent or sexual subject matter only be accessible to users over a certain age, (6) that application falling within a certain category (e.g., violent video games) be prohibited or limited to certain times and/or durations of usage, etc.

The policies or parameters discussed above may be included in the external database 74, specified locally in policy database 62, and/or derived through a combination of the external information and locally specified preferences. Also, in addition to or instead of actively restricting usage, the exemplary systems/methods may be used to simply passively monitor the use of a computer, noting what programs were used, accumulated usage times, time of day, etc.

Typically, during installation of the described management software, service 68 (e.g., an XP service), GUI application 66 and system shell hook 70 are installed on computer 20, in addition to the previously-described databases. During the installation, or at any time afterwards, supervising user 22 establishes user names and passwords. It will be appreciated that multiple accounts may be created, corresponding to multiple different supervised users 24. After creating user accounts, the supervising user may revise policy database 62 by defining management information that is to govern the management of applications on computer 20. As described above, master database 60 and policy database 62 are eventually combined to create an efficient, locally-customized database of applications 64 that governs management of computer 20. If multiple users are defined on the computer, the current invention uses one lookup database that merges the separate lookup databases that each user would otherwise generate. Thus the system need only look at the one lookup database, regardless of the number of users. While this is the particular mode of installation for the present example, it may also be advantageous in the case of several users not to merge the separate lookup databases and, instead, direct the service and hook to the lookup database that pertains to only the current user.

For example, as described above, after user accounts are created, the supervising user may employ GUI application 66 to modify policy database 62 to select which applications a particular supervised user 24 is permitted to run. They can additionally supply time periods when those restrictions apply. Finally, they can specify that certain applications (or all applications sharing a specified characteristic) can only be run for a certain amount of time for a given period (e.g., a certain number of hours per week).

As described above, master database 60 and policy database 62 may be combined to create a compiled lookup data collection (e.g., lookup database 64). Lookup database 64 includes management information for all programs of interest, and may indicate program-specific constraints and ratings, and/or management information applicable to programs having specified characteristics. If a program in master database 60 is unobjectionable and no policy for any user exists to restrict its use, no record of the program is copied to lookup database 64. In this way, the database is kept relatively small and efficient.

On computer startup, service 68 installs system-wide shell hook 70 that is to be injected into each application by the operating system upon application startup. If more then one user is defined, a logon screen may be displayed to the user, requiring entry of a password or other identifier before any non-system executables are allowed to launch.

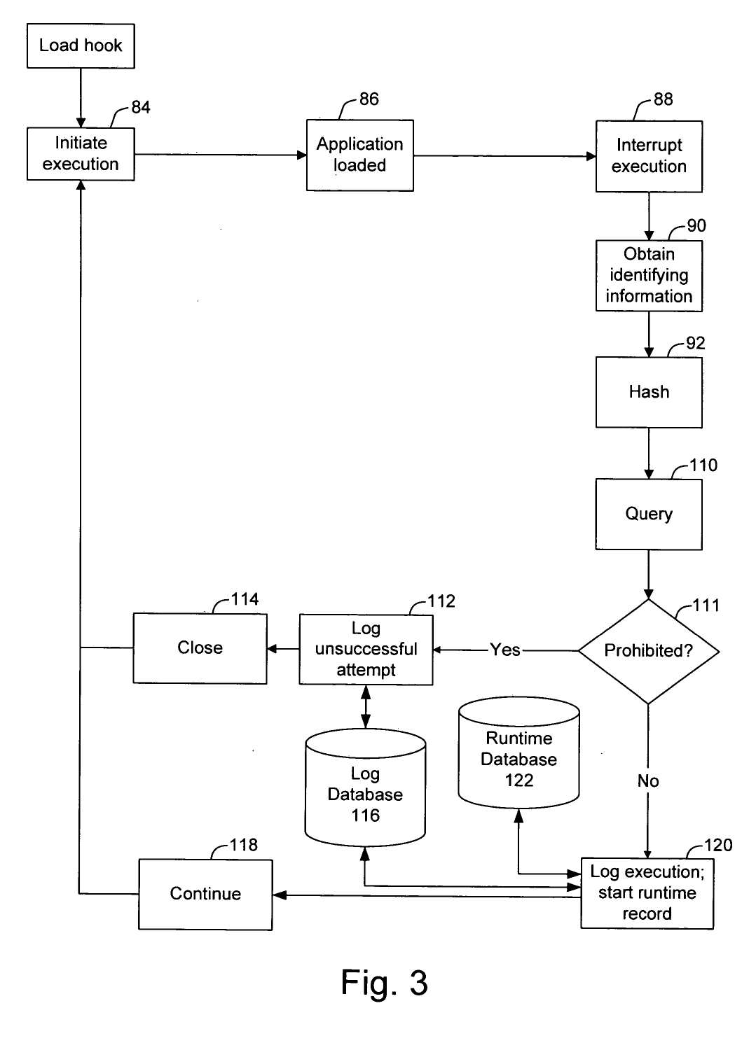

Referring to FIG. 3, upon “double clicking” or otherwise initiating application execution, as shown at 84, the operating system injects an instance of shell hook immediately after 86 (e.g., in this example, a .dll component) into the application. The shell hook interrupts initial execution at 88 and collects information about the application being run, and may send this information to service 68 via interprocess communication techniques. Service 68 may then collect additional information about the process and create a hash based on this information. If, instead of a shell hook, one were to use a software driver that detected the creation of new processes, the driver would be inserted immediately after 84. The processing would otherwise be similar.

Typically, it will be desirable to employ various methods to guard against intended or accidental compromise of the ability of management software 26 to identify requested applications. Accordingly, at steps 88, 90 and 92, it will often be desirable to hash core executable code or other identifying data that cannot be easily accessed or replaced. In this regard, it will be appreciated that application programs 96 (FIG. 1) typically include various components. Some components are easily accessed, replaced and/or subject to tampering, such as filename 98 and header information 100. In many cases, it is relatively easy to replace these components without impairing the ability to run the core executable code 102 of the program. Accordingly, it will often be desirable for shell hook 70 or service 68 to obtain a portion of core executable code 102, and then perform a hash, in order to minimize the risk of the software failing to properly identify a requested application.

Referring again to FIG. 3, once the unique hash value is obtained, lookup database 64 is queried for the generated hash value, as shown at 110. If the hash value is present in database 64, a signature for the application is compared to the generated hash to determine if an exact match exists, so as to securely and conclusively identify the application being requested. The signature may include unique pieces of data from the application such as actual samples of the bit streams embedded within it, as described above in the discussion of core executable code 102.

In addition, the same code can be hashed in multiple ways, using different algorithms, so as to more completely identify the application. For example, the executable component of a program that installs other programs (an installer) may appear identical, no matter what program it happens to be installing. However, if the application can be identified as a particular installer, the service can hash a different area of the application and detect and identify its “payload”. Thus, for some programs a proper identification may be a two or more tier process. Another place where this process is common is with Java application which first invoke Java and then use the Java program to execute the actual code of interest.

Based on the relevant management information in lookup database 64, a determination is made at 111 on whether or not to allow the program to execute. As described above, allowing or preventing program execution may be based on nearly limitless combinations of criteria implemented within the management information stored in lookup database 64. Among other things, determination on whether to permit or prevent program execution may be based on (1) user identity; (2) application identity; (3) a rating of the application, such as a content-based rating, established locally within policy database 62 or pre-configured via a third-party rating in master database 60; (4) content of the application, such as violent content, as determined locally by supervisor 22 or externally by a third party; (5) time of day; (6) accumulated time of usage for a given supervised user, specified application or group of applications sharing a characteristic; and/or any other desired criteria.

If application execution is prevented, the unsuccessful attempt may be logged and the application closed, as shown at 112 and 114. A separate log database 116 may be included to log such activity. In the event that continued execution is permitted, as at 118, the successful execution may be logged, at 120. As also shown at 120, runtime database 122 may be updated with run time records that may be used in performing subsequent management functions.

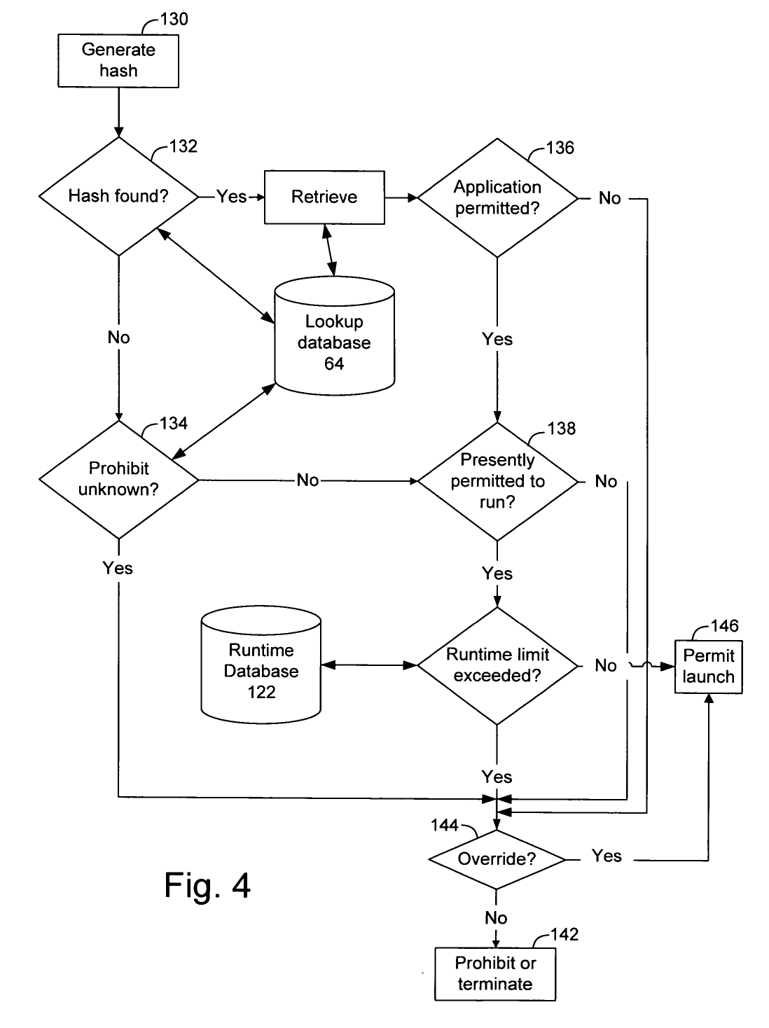

Referring now to FIG. 4, it will be appreciated that the systems and methods of the present description may be flexibly configured to take different actions in the event that a requested application cannot be identified. The unique hash value is generated as before at 130. Lookup database 64 is then queried at 132 to determine whether a match exists. If unknown applications are permitted to run at 134 (which may depend on the identity of the logged-in supervised user 24), execution of the application may proceed, if other constraints such as user time limits 138 do not prohibit execution. If unknown applications are prohibited, execution terminates (unless the administrator executes an override 144) and the unsuccessful attempt may be logged as described with reference to FIG. 3.

Referring still to the example of FIG. 4, if a match is found, the respective record is retrieved to access the corresponding management information. At 136, criteria other than time-based criteria are assessed. If these criteria are satisfied, processing proceeds to 138, where the appropriate management information is assessed to determine whether the application is permitted to run at the particular time that it is requested. If the requested time is disallowed (e.g., a child requesting a particular software game after bedtime), the application launch is prohibited at 142, assuming an override password is not provided at 144.

In the event that the initial time constraint condition is satisfied, or an override password is provided, continued execution is permitted at 146, though the management software may continue to monitor program execution to ensure that run-time time limits are not exceeded. Once such a time limit is exceeded, as determined by consulting management information in lookup database 64 or timing information in runtime database 122, further execution is prohibited unless an override is entered at 144. As in the previous examples, various databases may be updated to reflect all of these activities.

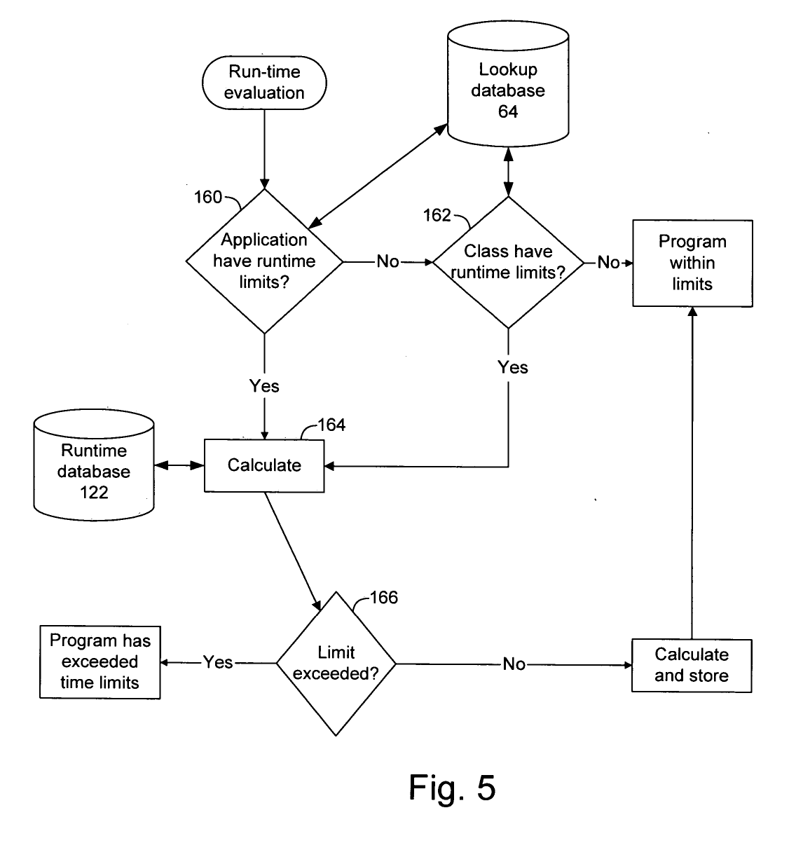

Referring to FIG. 5, an exemplary method for conducting runtime evaluations is depicted. As previously discussed, a separate runtime database 122 may be employed to track execution times and aid in determining whether applications are permitted to run. In addition to or instead of such a separate database, these functions may be performed by lookup database 64. At 160 and 162, a determination is made as to whether the requested application (e.g. a specific game) or class to which it belongs (e.g. “games”, “violent content”, “nudity”) has any runtime limits. In the event of such a limit, a runtime calculation is made at 164 (e.g., with reference to information in runtime database 122) and a determination occurs at 166 as to whether any applicable limit has been exceeded (e.g., a maximum number of hours per week that user 24 can play a particular video game). If the determination at 160 and 162 is negative, or if a time-limited application is within the specified limits, processing is permitted to continue as described with reference to FIGS. 3 and 4, in which case continued run-time monitoring may be performed as appropriate. If a determination is made at 166 that a runtime limit has been exceeded, then further execution is prevented, as previously described. In any case, as described above, all relevant activity may be monitored and incorporated into the relevant logs and databases.

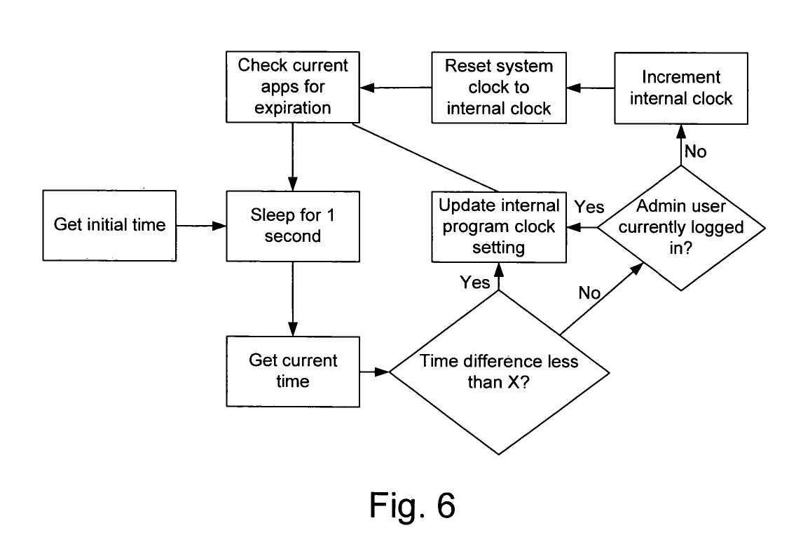

Referring now to FIGS. 6-8, further exemplary methods will be described for monitoring applications that are initially permitted to run on computer 20. On a regular basis, various clocks, including internal program clocks and cached clocks, may be compared and/or synchronized with the main system clock, as shown in FIG. 6. Attempts to tamper with the system clock by non-administrators may thereby be noted and prevented. As part of this regular verification, management information is examined to identify applications exceeding their specified time limits, as previously described.

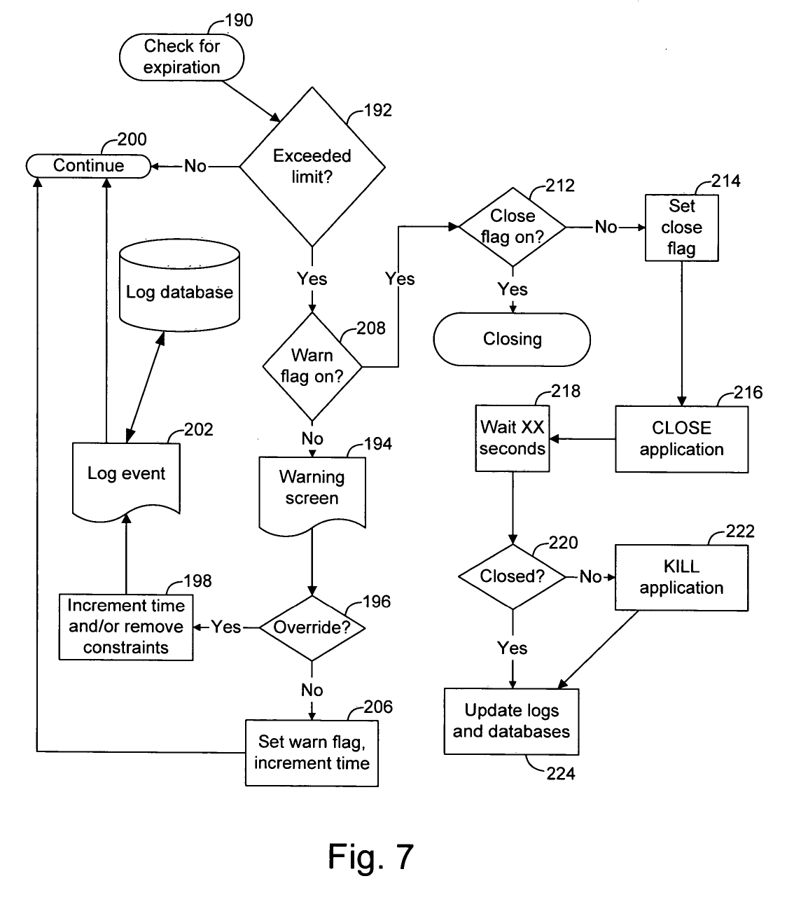

When a time limit is exceeded (e.g., as determined at 190 and 192 in FIG. 7) or an application is to be closed for some other reason, a full screen message that cannot be moved to the background may be displayed, as shown at 194. Supervised user 24 may then be offered an opportunity to override the limit by entering an override password (e.g., the password of supervising user 22), as described with reference to FIG. 4 and shown in the present example at 196. If an override is entered, constraints may be removed, as shown at 198, and application execution may continue at 200, with appropriate logging at 202. Instead of indefinitely removing constraints at 198, the constraints may be removed for some interval. At the expiration of the interval, a further override would be required to continue processing.

If an override is not provided, supervised user 24 may provide confirmation, such as with a mouse click, that they have received the warning. Then, at 206, the permitted runtime is incremented by a predetermined interval. Usually, this predetermined interval is relatively short (e.g., five minutes) and is selected to give the user an opportunity to save work, close files or perform other “cleanup” tasks prior to the application being automatically shut down. As shown at 208 and 206, the provision of the warning screen is governed by the status of a warning flag. If the warning flag is off (e.g., indicating that no warning has yet been given), then the warning screen is presented and processing proceeds as just described. Once a warning is given and its receipt is confirmed by the user, the flag is turned on at 206. Thus, when the additional time added at 206 expires, the warning process is bypassed at 208 and the management software proceeds to processing steps which close the application.

Specifically, at 212, a close flag is evaluated and, if the close flag is turned on, that indicates that the application is in the process of closing. Otherwise, the flag is set at 214, closing is initiated at 216. After a predetermined delay at 218, the management software assesses at 220 whether the application has been closed. If not, the program is forced closed at 222. In either case, the relevant activity is recorded as appropriate at 224.

Alternatively, step 212 can be configured differently so that the flag processing and various mechanisms that follow which cause the application to stop are not executed. Instead, step 212 can cause a screen to pop up to the foreground, blocking the current application from view, at increasingly frequent intervals until the timed-out application is closed down. This can effectively cause a user to close the forbidden application as it is otherwise unusable and this approach would also avoid any security or system concerns that some people may express when one application closes down another application.

Aspects of the exemplary method described with reference to FIG. 7 may be flexibly configured by supervising user 22. For example, supervising user 22 may specify whether or not a warning is to be given, how much additional time is allowed after provision of the warning, how long a delay is to occur before applications are forced closed, etc.

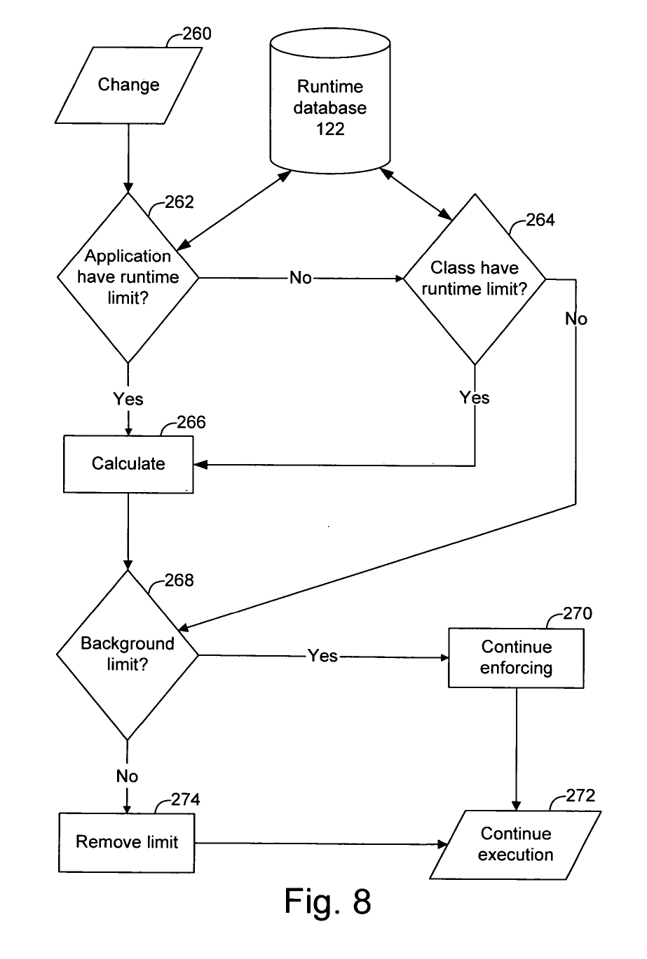

Referring now to FIGS. 1 and 8, shell hook 70 may be configured to detect whether a running application is being actively used, so as to appropriately assess actual execution times. For example, in a windows environment, an application may be in an active or passive state, depending on whether its main window is in the foreground or background. In addition to or instead of shell hook 70, detection of whether a program is active or passive may be performed by an additional hook or other method.

In any case, a swapping of application windows corresponding to a new application becoming active is detected at 260 in FIG. 8. At 262 and 264, a determination is made as to whether the newly-active program has runtime limits, or belongs to a class of applications having runtime limits. If a limit is specified, a recalculated time limit is generated at 266. Also, regardless of whether the newly-active application has runtime limits, an assessment may be made as to whether runtime limits for the background application should continue to be enforced (e.g., as shown at 268, 270, 272 and 274).

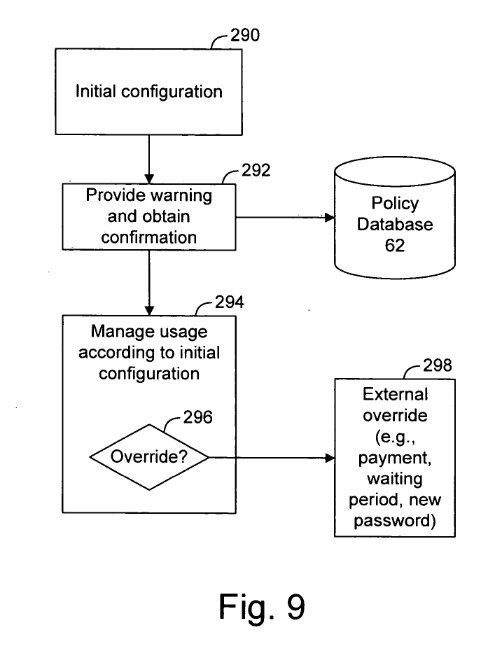

The present software, systems and methods may be advantageously employed in a variety of settings, including household use (e.g., supervision of children), employment and educational settings, and any other setting in which it is desirable and/or necessary to monitor and control computer usage. FIG. 9 depicts an intriguing example of how management software 26 may be employed. The example of FIG. 9 differs from the previous examples in that it limits the ability of the supervising user 22 to subsequently revise their own decisions about how computer 20 is to be used. This operational mode has many potential advantages in the treatment of addictive behaviors that involve use of computers (e.g., gambling, excessive gaming or internet use, pornography consumption, etc.).

Referring specifically to FIG. 9, the exemplary depicted method allows the user to specify initial configuration settings, and then select an option to “fix” those settings in a manner that requires external intervention to modify or undo. At 290, the method includes initially configuring the management information for computer 20 (e.g., through entry of locally customized parameters into policy database 62). Upon completion of setup, the method may include providing the user with a warning at 292 that the configuration changes are irreversible without external intervention. Upon receipt of confirmation, processing proceeds to 294, where management software enters its normal operating mode, in which it manages application usage according to the initial parameters specified during setup. At this point, the software is locked into enforcement mode and access to setup interface is at least temporarily disabled. Unlike in the previous examples, no local password is available to allow any user (including supervisor 22) to override the controls that are put in place at step 292. Instead, as shown at 296 and 298, an external entity must be contacted to override the controls. Override may require payment to the external entity, and/or a predetermined waiting period may have to elapse before an override is allowed. Instead of an external entity enabling the override, the management software may simply be configured so that, upon receipt of a requested override, any modification to the initial configuration is automatically delayed by some set interval.

In this particular case the override password can be generated in several ways. The override password could be created on a secure server and passed in a representative form (eg, the hash of the password or the password itself) in a secure fashion to the computer of supervisor 22 via an encrypted communication from some other authority. There it would be stored in a encrypted fashion in the user's policy database. Thus, the external authority would know the password but user 22 would not. Another approach would be to hard code various keys into the program and give those same keys to the outside authority. Alternatively, the override password could be produced internally and differ according to an algorithm that might include fixed factors (like a computer's ID, its operating system's ID, its disk ID, etc.) and at least one variable factor, such as the date or time. These values would be condensed into a key that would then require a corresponding key to be typed in to “unlock” or override the current setting. This “matching” key would require the use of a private key to generate and the external authority would have sole access to that. The technology surround such password and private key/public key solutions has been widely described and does not need to be further repeated here. The important element that is innovative is to use such technology coupled with the invention herein reported to restrict or outright prohibit User 22 from changing his restrictions.

A further elaboration of this invention might anticipate a program, as described here, with all the restrictions being based on an external authority's criteria and that User 22's only role would be to install the application (assuming the external authority did not do so). The external authority would then set the appropriate restrictions and override password, most likely via a secure Internet connection. Thus, for example, the Department of Justice might restrict the computer activities of paroled felons, especially those who were known to use computers in their crimes.

This method and process of relinquishing control of an application that performs management, filtering, restricting, or screening of content or activities from user 22 and gives it to some external authority (eg., a company, a physician, a government, etc.) can be expanded past the process described up to now. More generally, this method and process has immediate applicability to expand the functionality of existing methods of Internet filtering such that, using this technique, the authority for the filter shall pass from the parent or employer to an external entity that is not subject to the temptations to override the settings to satisfy addictive, compulsive, anti-social, or self-destructive impulses. Thus, for example, Internet filters could be specialized, using this technology, so as to limit access to specific sites that cater to such behaviors as gambling, browsing, chatting, pedophilia, sexual addiction, gaming.

While the present embodiments and method implementations have been particularly shown and described, those skilled in the art will understand that many variations may be made therein without departing from the spirit and scope of the invention. The description should be understood to include all novel and non-obvious combinations of elements described herein, and claims may be presented in this or a later application to any novel and non-obvious combination of these elements. Where claims recite “a” or “a first” element or the equivalent thereof, such claims should be understood to include incorporation of one or more such elements, neither requiring nor excluding two or more such elements.

1. A system for managing usage of a computer by a supervised user, comprising:
an interposed software process configured to be loaded into memory of the computer; and
an application database accessible by the interposed software process, where the interposed software process and application database are configured to identify management information stored within the application database and associated with an application running on the computer and where, based on such management information, the system selectively permits or prevents use of the application by the supervised user.

2. The system of claim 1, where the application database is stored on the computer.

3. The system of claim 2, where the application database is generated by obtaining a master external database and by specifying local usage parameters.

4. The system of claim 1, where the management information contains information relating to subject matter of each of a plurality of applications, and where the interposed software process and application database are configured to detect attempts to launch a selected one of the plurality of applications, and where, in response to such an attempted launch, the system is configured to selectively permit or prevent execution of the selected application based on the subject matter of the selected application.

5. The system of claim 1, where the management information contains information relating to a permitted user list for each of a plurality of applications, and where the interposed software process and application database are configured to detect attempts to launch a selected one of the plurality of applications, and where, in response to such an attempted launch, the system is configured to selectively permit or prevent execution of the selected application based on the permitted user list for the selected application.

6. The system of claim 1, where the management information contains information relating to permitted usage times for each of a plurality of applications, and where the interposed software process and application database are configured to detect attempts to launch a selected one of the plurality of applications, and where, in response to such an attempted launch, the system is configured to selectively permit or prevent execution of the selected application based on the permitted usage times for the selected application.

7. The system of claim 1, where the management information contains information relating to a permitted usage duration for each of a plurality of applications, and where the interposed software process and application database are configured to detect attempts to launch a selected one of the plurality of applications, and where, in response to such an attempted launch, the system is configured to selectively permit or prevent execution of the selected application based on the permitted usage duration for the selected application.

8. The system of claim 1, where the management information contains information relating to a rating of each of a plurality of applications, and where the interposed software process and application database are configured to detect attempts to launch a selected one of the plurality of applications, and where, in response to such an attempted launch, the system is configured to selectively permit or prevent execution of the selected application based on the rating of the selected application.

9. The system of claim 8, where for each of the plurality of applications, the rating is based on a third-party evaluation of the application.

10. The system of claim 1, where the interposed software process is a system-wide shell hook.

11. The system of claim 10, where an instance of the system-wide shell hook is injected into the application running on the computer after a request by the supervised user to initiate execution of the application.

12. The system of claim 1, where the interposed software process is a software driver.

13. A system for managing usage of a computer by a supervised user, comprising:
an application database containing management information associated with a plurality of application programs; and
an interposed software process configured to activate after and in response to a request by the supervised user to launch a requested application program on the computer, where based on a portion of executable code of the requested application program obtained by the interposed software process, the system is configured to hash a signature for the requested application program and use the signature to securely and uniquely determine whether the application database contains management information for the requested application program, and where the system, in response to such determination, is configured to control usage of the requested application program by the supervised user.

14. The system of claim 13, where the application database is stored locally on the computer.

15. The system of claim 14, where the application database is derived from a master database that is generated externally.

16. The system of claim 15, where the application database is generated by customizing the master database.

17. The system of claim 14, where the application database includes age-level appropriateness ratings for a plurality of application programs.

18. The system of claim 14, where the application database includes identification of application programs containing sexual subject matter.

19. The system of claim 14, where the application database includes identification of application programs containing violent subject matter.

20. The system of claim 14, where the application database includes identification of application programs containing religious subject matter.

21. The system of claim 14, where the application database includes identification of a degree to which application programs are considered objectionable.

22. The system of claim 13, where the interposed software process is a system-wide shell hook.

23. The system of claim 22, where an instance of the system-wide shell hook is injected into the requested application program after the request to launch the requested application program is made by the supervised user.

24. The system of claim 13, where the interposed software process is a software driver.

25. The system of claim 13, where the management information includes a usage time constraint for at least one of the plurality of application programs, and where the system is configured to enforce the usage time constraint when the supervised user requests execution of the at least one of the plurality of application programs.

26. The system of claim 25, where the usage time constraint includes permitted usage times for the at least one of the plurality of application programs.

27. The system of claim 25, where the usage time constraint includes a permitted usage duration for the at least one of the plurality of application programs.

28. The system of claim 13, where the software is configured to perform multiple hash iterations in order to securely and uniquely determine whether the application database contains management information for the requested application program.

29. A method of managing computer usage, comprising:
software configured to be loaded on a computer, the software including:
a setup interface configured to permit an end user to set initial constraints governing usage of applications on the computer;
a database configured to store the initial constraints; and
a detection mechanism, where the software is configured to run in an enforcement mode, in which the software is operable to use the detection mechanism and database to identify a requested application, determine whether any of the initial constraints are applicable, and enforce any such applicable constraints,
where the setup interface is configured to lock the initial constraints set by the end user, to thereby at least temporarily prevent the end user from disabling enforcement of the initial constraints.

30. The method of claim 29, where the initial constraints are locked such that they cannot be disabled without intervention by an outside entity.

31. The method of claim 30, where the intervention by the outside entity includes the outside entity generating a new password and providing such new password to the end user, the new password enabling the end user to regain access to the setup interface.

32. The method of claim 30, where the intervention by the outside entity includes remote issuance of a command that enables the end user to regain access to the setup interface.

33. The method of claim 29, where the initial constraints are locked such that they cannot be disabled by the end user until passage of a predetermined time interval.

34. A method of managing computer usage, comprising:
detecting activation of an application on a computer;
performing a hash on a portion of executable code of the application to obtain an application signature; and
comparing the application signature with contents of a database to identify the application and determine whether any usage constraint has been associated with the application and, if so, enforcing such usage constraint.

35. The method of claim 34, where determining whether any usage constraint has been associated with the application includes referring to the database to determine whether the application has been indicated as containing objectionable content or subject matter.

36. The method of claim 35, where determining whether the application has been indicated as containing objectionable content or subject matter includes determining whether the application has been indicated as containing excessively violent subject matter.

37. The method of claim 35, where determining whether the application has been indicated as containing objectionable content or subject matter includes determining whether the application has been indicated as containing inappropriate sexual subject matter.

38. The method of claim 35, where determining whether the application has been indicated as containing objectionable content or subject matter includes determining whether the application has been indicated as containing inappropriate religious subject matter.

39. The method of claim 35, where determining whether the application has been indicated as containing objectionable content or subject matter includes making such determination based on an age of a user requesting activation of the application.

40. The method of claim 34, where determining whether any usage constraint has been associated with the application includes referring to the database to determine whether the application has been indicated as having an associated usage time constraint.

41. The method of claim 40, where the usage time constraint includes permitted usage times for the application.

42. The system of claim 40, where the usage time constraint includes a permitted usage duration for the application.

43. The method of claim 34, further comprising generating the database by obtaining a copy of a master external database and customizing the master external database with local preferences concerning how the computer is to be managed.

44. A system for managing usage of a computer by a supervised user, comprising:
a system-wide shell hook; and
a local applications database, where the local applications database is generated by obtaining a master external database and by specifying local usage parameters,
where the shell hook is configured to operatively interact with an operating system of the computer so as to detect launching of application programs on the computer and obtain information associated with such application programs, and where, based on information obtained by the shell hook from a given application program, the system is configured to selectively permit or prevent use of the given application program by the supervised user, in accordance with management information associated with the given application program, where the management information is stored in the local applications database and is derived from the master external database and local usage parameters.

45. A method of managing computer usage, comprising:
setting usage constraints governing usage of a computer,
placing computer in enforcement mode, in which usage of the computer is monitored and restricted in accordance with the usage constraints; and
at least temporarily preventing modification or removal of the usage constraints and at least temporarily locking the computer in enforcement mode, to thereby at least temporarily prevent any end user, including an end user involved in setting the usage constraints, from disabling enforcement of the usage constraints.

46. The method of claim 45, where the usage constraints include specification of permitted or prohibited application programs.

47. The method of claim 45, where the usage constraints include limitation of or prohibition against use of application programs capable of external communications.

48. The method of claim 47, where the usage constraints include limitation of or prohibition against use of application programs capable of accessing the Internet.

49. The method of claim 48, where the usage constraints include limitation of or prohibition against accessing particular resources on the Internet.

50. The method of claim 48, where the usage constraints include limitation of or prohibition against accessing Internet sites featuring pornography.

51. The method of claim 48, where the usage constraints include limitation of or prohibition against accessing Internet sites featuring gambling.

52. The method of claim 48, where the usage constraints include limitation of or prohibition against accessing Internet sites featuring gaming.

53. The method of claim 45, where the usage constraints include limitation of or prohibition against use of computer games.

54. The method of claim 45, further comprising allowing modification or removal of the usage constraints and unlocking the computer from enforcement mode only after elapse of a predetermined period of time.

55. The method of claim 45, further comprising allowing modification or removal of the usage constraints and unlocking the computer from enforcement mode only after occurrence of an external override.

56. The method of claim 55, where the external override includes remote issuance of a command which unlocks the computer from enforcement mode.

57. The method of claim 55, where the external override is an externally-generated password.

58. A system for managing computer usage, comprising:
software configured to be loaded on a computer, the software including:
a setup interface configured to permit an end user to set usage constraints governing usage of the computer; and
an enforcement process configured to run on the computer when the software is placed in an enforcement mode,
where the enforcement process is configured so that, when the software is in enforcement mode, the enforcement process is responsive to prevent attempts by the end user to use the computer in violation of the usage constraints, and
where the software is configured to at least temporarily block access to the setup interface and lock the software in enforcement mode, to thereby at least temporarily prevent modification or removal of the usage constraints, and thereby prevent the end user from disabling enforcement of the usage constraints.

59. The system of claim 58, where the usage constraints are derived from an external database.

60. The system of claim 59, where the usage constraints are stored in a local database, and are generated by combining data from the external database with local customized parameters specified by the end user.

61. The system of claim 58, where the usage constraints include specification of permitted or prohibited application programs.

62. The system of claim 58, where the usage constraints include limitation of or prohibition against use of application programs capable of external communications.

63. The system of claim 62, where the usage constraints include limitation of or prohibition against use of application programs capable of accessing the Internet.

64. The system of claim 63, where the usage constraints include limitation of or prohibition against accessing particular resources on the Internet.

65. The system of claim 63, where the usage constraints include limitation of or prohibition against accessing Internet sites featuring pornography.

66. The system of claim 63, where the usage constraints include limitation of or prohibition against accessing Internet sites featuring gambling.

67. The system of claim 63, where the usage constraints include limitation of or prohibition against accessing Internet sites featuring gaming.

68. The system of claim 58, where the usage constraints include limitation of or prohibition against use of computer games.

69. The system of claim 58, where the software is configured to block access to the setup interface and lock the software in enforcement mode for a predetermined period of time.

70. The system of claim 58, where the software is configured to block access to the setup interface and lock the software in enforcement mode until occurrence of an external override.

71. The system of claim 70, where the external override is a password generated and provided to the end user by an external entity.

72. The method of claim 70, where the external override is a remotely-issued command which enables the end user to regain access to the setup interface.
